(19) United States
(12) Patent Application Publication
(10) Pub. No.: US 2010/0266864 A1
(43) Pub. Date: Oct. 21, 2010

(54) Ultra-thin heat pipe

(75) Inventor: Ke-Chin Lee, Taipei (TW)

Correspondence Address: BACON & THOMAS, PLLC, 625 SLATERS LANE, FOURTH FLOOR, ALEXANDRIA, VA, 22314-1176, US

(73) Assignee: YEH-CHIANG TECHNOLOGY CORP., Taipei (TW)

(21) Appl. No.: 12/588,128

(22) Filed: Oct. 6, 2009

(30) Foreign Application Priority Data
Apr. 16, 2009 (TW) 098112615

(51) Int. Cl. B32B 15/16; B32B 15/01

(52) U.S. Cl. 428/557; 428/553

(57) ABSTRACT

An ultra-thin heat pipe comprises a flat metal tube and one or more sintered powder portions. The flat metal tube has an upper tube wall, a lower tube wall and two lateral walls connecting with the upper tube wall and the lower tube wall. The sintered powder portions extends axially and are formed on an inner face of at least one of the upper tube wall, the lower tube wall and the lateral walls such that vapor passage space is formed at one or more sides of the sintered powder portions.

### BACKGROUND OF THE INVENTION

1. Field of the Invention

The present invention relates to an ultra-thin heat pipe, especially to a sintered ultra-thin heat pipe.

2. Brief Description of the Prior Art

It is known that a heat pipe is a device having high heat transfer capability. The liquid working medium filled in the heat pipe is evaporated at the hot segment into vapor. The vapor moves at a high speed along the vapor passage toward the cold segment. Then, the vapor is condensed into liquid working medium at the cold segment, and the liquid working medium, under the capillary action, returns to the hot segment through the wick structure. In this manner, heat can be transferred promptly from the hot segment to the cold segment.

Accompanying with the trend of miniaturization and flattening of electronic products, there is a demand for a flat heat pipe. U.S. Patent Publication No. 2002179288A1 proposes to insert a pre-fabricated pipe wick in a tubular copper tube and then compress the tubular copper tube into a flat copper tube. A flat heat pipe is manufactured by such a manner.

However, in this flat heat pipe formed by inserting an insert into a metal tube, higher thermal contact resistance is generated between the insert and the metal tube. This disadvantageous to heat transfer through the interface between the insert and the metal tube. Additionally, the insert is usually formed by a metal mesh. With regard to the properties of capillary structure associated with the heat pipe performance such as permeability, porosity and capillary pressure etc., the metal mesh is by no means superior to sintered powder.

### SUMMARY OF THE INVENTION

In view of the above fact, the object of this invention is to provide an ultra-thin heat pipe which can be compressed sufficiently and which still can keep sufficient space necessary for a vapor passage.

Another object of the present invention is to provide an ultra-thin heat pipe which can be compressed sufficiently without damaging the wick structure.

Still another object of the present invention is to provide an ultra-thin heat pipe which can reduce the thermal contact resistance between the wick structure and the metal tube.

The ultra-thin heat pipe according to the present invention comprises an elongated flat metal tube and at least one sintered powder portion. The flat metal tube has an upper tube wall, a lower tube wall and two lateral walls connecting with the upper tube wall and the lower tube wall. The sintered powder portion extends axially and is formed on an inner face of one of the upper tube wall, the lower tube wall and the lateral walls such that a vapor passage space is formed at one or more sides of the sintered powder portion.

Inasmuch as the sintered powder portion is directly formed on the tube wall of the metal tube, the thermal contact resistance between the wick structure and the metal tube is further reduced.

Inasmuch as the sintered powder portion is partially formed on the tube wall of the metal tube, the sintered powder portion is not damaged even if the metal tube formed with the sintered portion is compressed into a flat form.

Inasmuch as the sintered powder portion is partially formed on the tube wall of the metal tube, a sufficient space necessary for a vapor passage can be kept after the metal tube is compressed into a flat form.

The above and other objects and advantages of the present invention will become apparent from the following description with reference to the accompanying drawings which illustrate examples of the present invention.

### DETAILED DESCRIPTION OF THE PREFERRED EMBODIMENTS

Now, the preferred embodiments according to the present invention will be described in conjunction with the accompanying drawings. For the sake of convenience, the drawings are not made to scale.

FIG. 1 is a perspective view showing the ultra-thin heat pipe according to the present invention which is indicated by reference 10.

The heat pipe 10 comprises a hollow metal tube 11 and a sintered powder portion formed on the inner face of the metal tube 11. The metal tube 11 is made, for example, from Cu, Al, stainless steel, Ti or Ni. The sintered powder portion is formed by sintering Cu powder, Al powder, Ni powder or nano carbon powder. A plurality of capillary grooves extending axially (not shown) may be formed on the inner wall face of the metal tube 11.

FIGS. 2 to 10 are cross sections perpendicular to the axial direction of the metal tube 11, which show various arrangements of the sintered powder portion.

The metal tube 11 includes an upper tube wall 14, a lower tube wall 15 and two lateral walls 16, 17 connected with the upper tube wall 14 and the lower tube wall 15.

In FIG. 2, the sintered powder portion 12 is formed axially on the upper tube wall 14. The sintered powder portion 12 is formed partially but not entirely on the upper tube wall 14 such that the space for the vapor passage is formed at both sides of the sintered powder portion 12. The sintered powder portion 12 is spaced from the lower tube wall 15 so that the area for evaporation is increased. If the sintered powder portion 12 formed on the upper tube wall is spaced from the lower tube wall 15 by several micrometers, for example, 50 μm or less, the gap formed between the sintered powder portion and the lower tube wall is capable of serving as a passage for delivering liquid working medium under capillary action. Though not shown in the drawings, the sintered powder portion may be formed on the lower tube wall and spaced from the upper tube wall.

The arrangement of the sintered powder portion shown in FIG. 3 is different from that shown in FIG. 2 in that the sintered powder portion 12 formed on the upper tube wall 14 is in contact with the lower tube wall 15. Though not shown in the drawings, the sintered powder portion may be formed on the lower tube wall and in contact with the upper tube wall.

In FIG. 4, the sintered powder portions 12, 13 are formed axially on the upper tube wall 14 and the lower tube wall 15 respectively. The sintered powder portions 12, 13 are aligned with and spaced from each other. If the sintered powder portions 12, 13 are spaced from each other by several micrometers, for example, 50 μm or less, the gap formed between the sintered powder portions 12, 13 is capable of serving as a passage for delivering liquid working medium under capillary action.

The arrangement of the sintered powder portion shown in FIG. 5 is different from that shown in FIG. 4 in that the sintered powder portions 12, 13 are in contact with each other.

In FIG. 6, the sintered powder portions 12, 13 are formed axially on the lateral walls 16, 17 respectively.

In FIG. 7, the sintered powder portions 12, 13 are formed axially on the upper tube wall 14 and spaced from the lower tube wall 15. Though not shown in the drawings, the sintered powder portions may be formed on the lower tube wall and spaced from the upper tube wall.

Different from the illustration of FIG. 7, the sintered powder portions 12, 13 formed on the upper tube wall 14 are in contact with the lower tube wall 15. Though not shown in the drawings, the sintered powder portions may be formed on the lower tube wall and in contact with the upper tube wall.

As shown in FIG. 9, the sintered powder portions 12, 13 are formed on the upper tube wall 14 and the lower tube wall 15 respectively and staggered with each other. The sintered powder portion 12 formed on the upper tube wall 14 is spaced from the lower tube wall 15 while the sintered powder portion 13 formed on the lower tube wall 15 is spaced from the upper tube wall 14. Although the cross section of the sintered powder portions shown in FIGS. 2 to 9 is substantially rectangular, it should be understood that the cross section of the sintered powder portions may be triangular, polygonal or may have an arc segment. In FIG. 10, the sintered powder portions 12, 13 having an arc profile are formed axially on the upper tube wall 14 and the lower tube wall 5 respectively. The sintered powder portions 12, 13 are aligned with and in contact with each other. Owing to the arc profile of the sintered powder portions 12, 13, the passages for delivering liquid working medium under capillary action are formed along both lateral edges of the contact region between the sintered powder portions 12, 13, that is, formed at the included angles 18, 19.

Preferably, a heat source is in thermal contact with the wall formed with the sintered powder portion. For example, the heat source is in thermal contact with the upper tube wall 14 in the arrangement as shown in FIGS. 2 and 3 while the heat source may be in thermal contact with the upper tube wall 14 or the lower tube wall 15 in the arrangement as shown in FIGS. 4 and 5.

The method for manufacturing the ultra-thin heat pipe according the present invention will be described as below.

Firstly, a tubular metal tube 11a is prepared, and then a cylindrical plug 30 is inserted into the tubular metal tube 11a as shown in FIG. 11.

The outer diameter of the cylindrical plug 30 is substantially equal to the inner diameter of the tubular metal tube 11a, and two grooves extending axially are formed on the circumferential surface of the cylindrical plug 30. The cross profile, the quantity and the location of the grooves may be changed optionally.

Cu powder is filled into the grooves 31. Then, the tubular metal tube 11a is placed in a heating furnace so as to sinter the Cu powder filled in the grooves into sintered powder portions.

After sintering, the cylindrical plug 30 is drawn out. As shown in FIG. 12, two sintered powder portions 12, 13 are axially formed on the tube wall of the tubular metal tube 11a.

In turn, the tubular metal tube 11a is compressed into a flat metal tube 11. For example, the tubular metal tube 11a is compressed into a flat form in a manner as shown in FIG. 13 so as to obtain the heat pipe as shown in FIGS. 4 and 5. Alternatively, the tubular metal tube 11a is compressed into a flat form in a manner as shown in FIG. 14 so as to obtain the heat pipe as shown in FIG. 6.

It is noted that instead of the grooves one or more flat surfaces extending axially is provided on the outer circumferential surface of the cylindrical plug. When the cylindrical plug is inserted in the tubular metal tube, spaces to be filled with powder is defined by the flat surfaces and the inner wall face of the tubular metal tube.

Advantageously, the sintered portion may further comprise a plurality of fine passages extending axially for reduction of flow resistance of the liquid working medium. For example, as shown in FIG. 15, the arrangement of the sintered portion is similar to the arrangement shown in FIG. 3, but the sintered portion in FIG. 15 is formed with a plurality of fine passages 13 extending axially.

The fine passages may be formed by a plurality of fine threads which are embedded axially in a powder portion to be sintered prior to sintering. During the sintering process, the fine threads are dissolved or burned out such that the fine passages are formed in the sintered powder portion. The fine threads may be made by resin, plastic, polymer, nylon, cotton, silk, ash-free material, natural fiber, artificial fiber or material capable of being dissolved or burned out at a temperature less than or equal to the sintering temperature.

While this invention has been described with reference to the embodiments, it should be understood that various changes and modifications could be made within the spirit and scope of the inventive concepts described. Accordingly, it is intended that the invention shall not be limited to the disclosed embodiments but have the full scope permitted by the language of the following claims..

### BRIEF DESCRIPTION OF THE ACCOMPANYING DRAWINGS

FIG. 1 shows a perspective view of the heat pipe according to the present invention;

FIGS. 2 to 10 are cross sections perpendicular to the axial direction of the metal tube, which show various arrangements of the sintered powder portion;

FIG. 11 shows that the cylindrical plug is inserted into the tubular metal tube;

FIG. 12 shows a tubular metal tube formed with sintered powder portions;

FIGS. 13 and 14 show a compressing manner by which the tubular metal tube is compressed into a flat form; and

FIG. 15 is a cross section of the heat pipe according to the present invention which shows the sintered powder portion formed with a plurality of fines passages.

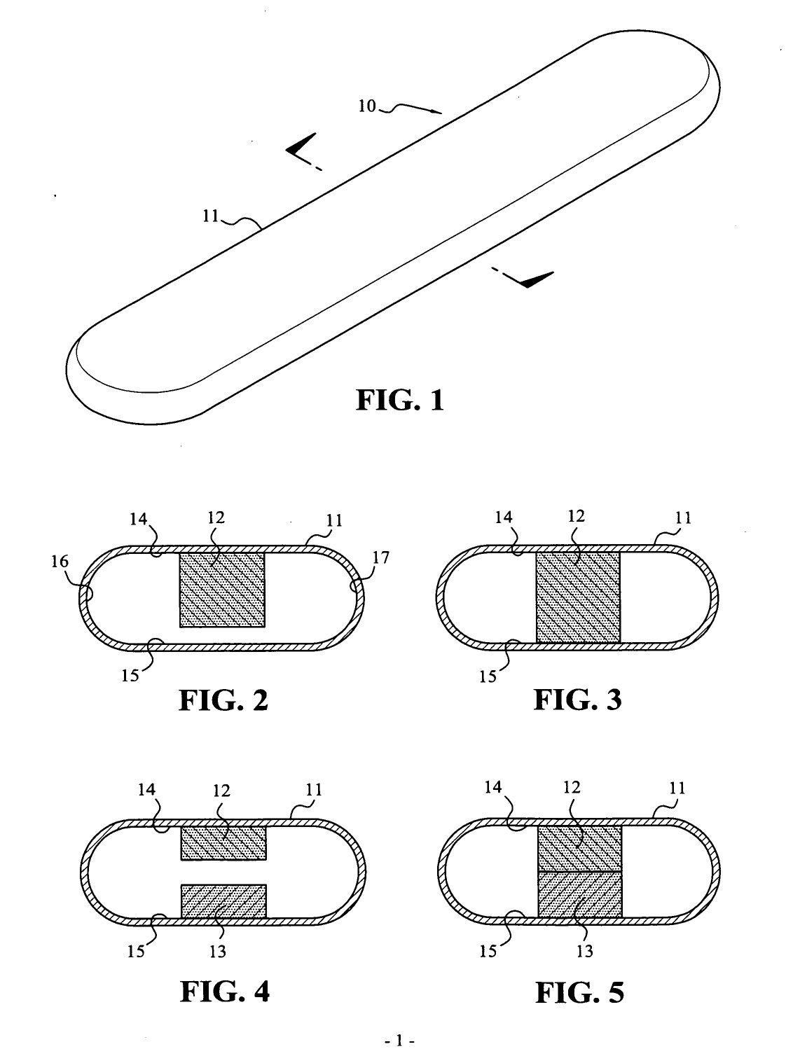

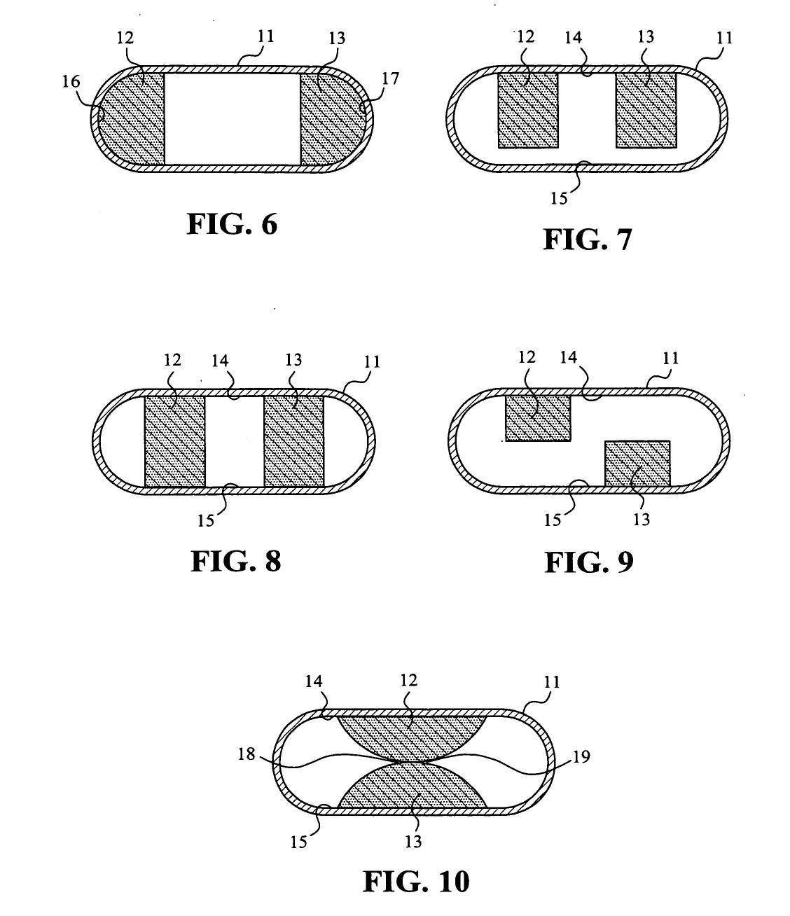

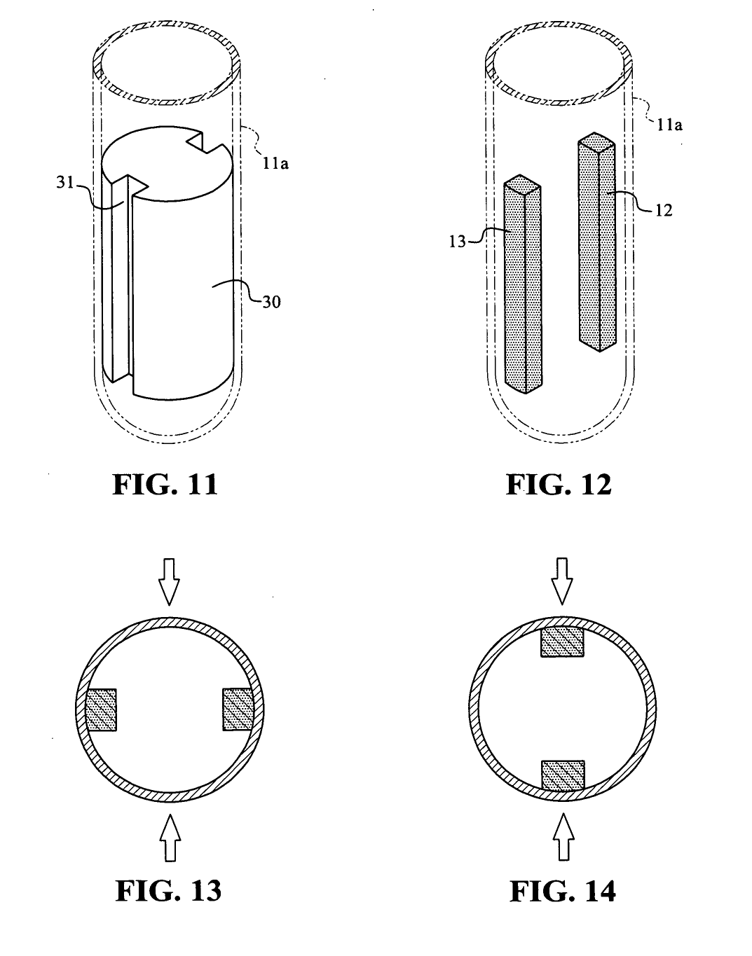

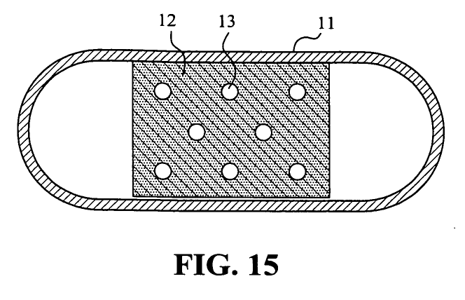

What is claimed is:

1. An ultra-thin heat pipe, comprising:
a flat metal tube, including an upper tube wall, a lower tube wall and two lateral walls connecting with the upper tube wall and the lower tube wall; and
at least one sintered powder portion extending axially and formed on an inner face of at least one of said upper tube wall, said lower tube wall and said lateral walls such that a vapor passage space is formed at one or more sides of said sintered powder portion.

2. The ultra-thin heat pipe according to claim 1, wherein said sintered powder portion is formed with a plurality of fines passages.

3. The ultra-thin heat pipe according to claim 1, wherein said sintered powder portion is formed on one of said upper tube wall and said lower tube wall and spaced from the other of said upper tube wall and said lower tube wall.

4. The ultra-thin heat pipe according to claim 1, wherein said sintered powder portion is formed on one of said upper tube wall and said lower tube wall and spaced from the other of said upper tube wall and said lower tube wall, such that a gap between said sintered portion, which is formed on the one of said upper tube wall and said lower tube wall, and the other of said upper tube wall and said lower tube wall serves as a passage delivering liquid working medium under capillary action.

5. The ultra-thin heat pipe according to claim 1, wherein said sintered powder portion is formed on one of said upper tube wall and said lower tube wall and in contact with the other of said upper tube wall and said lower tube wall.

6. The ultra-thin heat pipe according to claim 5, wherein said sintered powder portion has an arc profile such that an included angle for delivering liquid working medium under capillary action is formed along each lateral edge of a contact region between said sintered powder portion and the other of said upper tube wall and said lower tube wall.

7. The ultra-thin heat pipe according to claim 1, wherein said heat pipe includes two sintered powder portions, one of the sintered powder portions is formed on said upper tube wall, the other of the sintered powder portions is formed on said lower tube wall, and said two sintered powder portions are aligned with and spaced from each other.

8. The ultra-thin heat pipe according to claim 7, wherein said two sintered powder portions are aligned with and spaced from each other such that a gap between said two sintered powder portions serves as a passage for delivering liquid working medium under capillary action.

9. The ultra-thin heat pipe according to claim 1, wherein said heat pipe includes two sintered powder portions, one of the two sintered powder portions is formed on said upper tube wall, the other of the two sintered powder portions is formed on said lower tube wall, and said two sintered powder portions are aligned with and in contact with each other.

10. The ultra-thin heat pipe according to claim 7, wherein each of said two sintered powder portions has an arc profile such that an included angle for delivering liquid working medium by capillary action is form along each lateral edge of a contact region between said two sintered powder portions.

11. The ultra-thin heat pipe according to claim 1, wherein said heat pipe includes two sintered powder portions, one of the two sintered powder portions is formed on said upper tube wall, the other of the two sintered powder portions is formed on said lower tube wall, and said two sintered powder portions are staggered with respect to each other, the one of said sintered powder portions formed on said upper tube wall is spaced from said lower tube wall, and the other of said sintered powder portions formed on said lower tube wall is spaced from said upper tube wall.

12. The ultra-thin heat pipe according to claim 1, wherein said heat pipe includes two sintered powder portions, one of the two sintered powder portions is formed on said upper tube wall, the other of the two sintered powder portions is formed on said lower tube wall, said two sintered powder portions are staggered with respect to each other, the one of said sintered powder portions formed on said upper tube wall is in contact with said lower tube wall, and the other of said sintered powder portions formed on said lower tube wall is in contact with said upper tube wall.

13. The ultra-thin heat pipe according to claim 1, wherein said heat pipe includes two sintered powder portions formed on said lateral walls respectively.

14. The ultra-thin heat pipe according to claim 1, wherein said heat pipe includes a plurality of sintered powder portions which are formed on one of said upper tube wall and said lower tube wall and spaced from each other, and said sintered powder portions are spaced from the other of said upper tube wall and said lower tube wall.

15. The ultra-thin heat pipe according to claim 1, wherein said heat pipe includes a plurality of powder sintered portions which are formed one of said upper tube wall and said lower tube wall and spaced from each other, and said sintered powder portions are in contact with the other of said upper tube wall and said lower tube wall.

16. The ultra-thin heat pipe according to claim 1, wherein said heat pipe includes a plurality of sintered powder portions which are alternately formed on said upper tube wall and said lower tube wall.
